(19) United States
(12) Patent Application Publication
(10) Pub. No.: US 2005/0105981 A1
(43) Pub. Date: May 19, 2005

(54) Hole cutter and method for producing

(75) Inventors: David Byrley, Stow, OH (US); Keith Savastano, Canton, OH (US)

Correspondence Address: HAHN LOESER & PARKS, LLP, One GOJO Plaza, Suite 300, AKRON, OH, 44311-1076, US

(73) Assignee: The M. K. Morse Company

(21) Appl. No.: 10/946,962

(22) Filed: Sep. 21, 2004

Related U.S. Application Data
(60) Provisional application No. 60/506,320, filed on Sep. 26, 2003.

(51) Int. Cl. B23B 51/04

(52) U.S. Cl. 408/204

(57) ABSTRACT

A hole cutter machine tool combines the characteristics and properties of a low-cost hole saw with the speed and performance of an annular cutter. The hole cutter comprises a cutter ring portion similar to an end portion of existing annular cutters with a carrier portion similar to the cup of a hole saw. In one embodiment the hole cutter has a threaded aperture which enables use with a standard hole saw arbor or with a replaceable arbor having an annular cutter shank. An embodiment of the method of making the hole saw includes a joining process in which the cutter ring is simultaneously attached to the carrier portion and heat treated.

This application claims the benefit of U.S. Provisional Patent application Ser. No. 60/506,320, filed Sep. 26, 2003, and herein incorporated by reference.

### TECHNICAL FIELD

The present invention relates to a machining tool and, more particularly, to a hole cutter machine tool which combines the characteristics and properties of a low-cost hole saw with the speed and performance of an annular cutter.

### BACKGROUND OF THE INVENTION

Hole saws and annular cutters are machine tools used in drilling operations to cut a hole of a desired size. Hole saws and annular cutters remove a ring of metal leaving a central core or plug which can be removed as one piece. This enables faster hole drilling and requires less energy as only the perimeter is cut as compared to a standard twist drill which requires the entire hole to be reduced to chips.

A hole saw is typically adapted to be used with a drill press or power drill that allows a user to make circular cut-outs in a material such as wood, steel, fiberglass, plastic, etc. A conventional hole saw includes a saw cup, an arbor, and a pilot bit. The saw cup typically includes a threaded aperture to receive a threaded end portion of the arbor. Other conventional hole saws may have the arbor welded to the saw cup. The pilot bit protrudes from the cutting edge of the saw to guide the saw during cutting. The saw cup generally includes a collection of teeth which are comprised of uniform size and orientation, or may include repetitive groups of different size and orientation. The teeth may also be carbon steel, high speed steel, carbide, diamond grit or tungsten carbide grit tipped. While hole saws have proven to operate in a generally satisfactory manner for relatively shallow holes and softer materials, their performance is often inadequate for deeper holes and harder materials, especially when a large number of holes need to be cut.

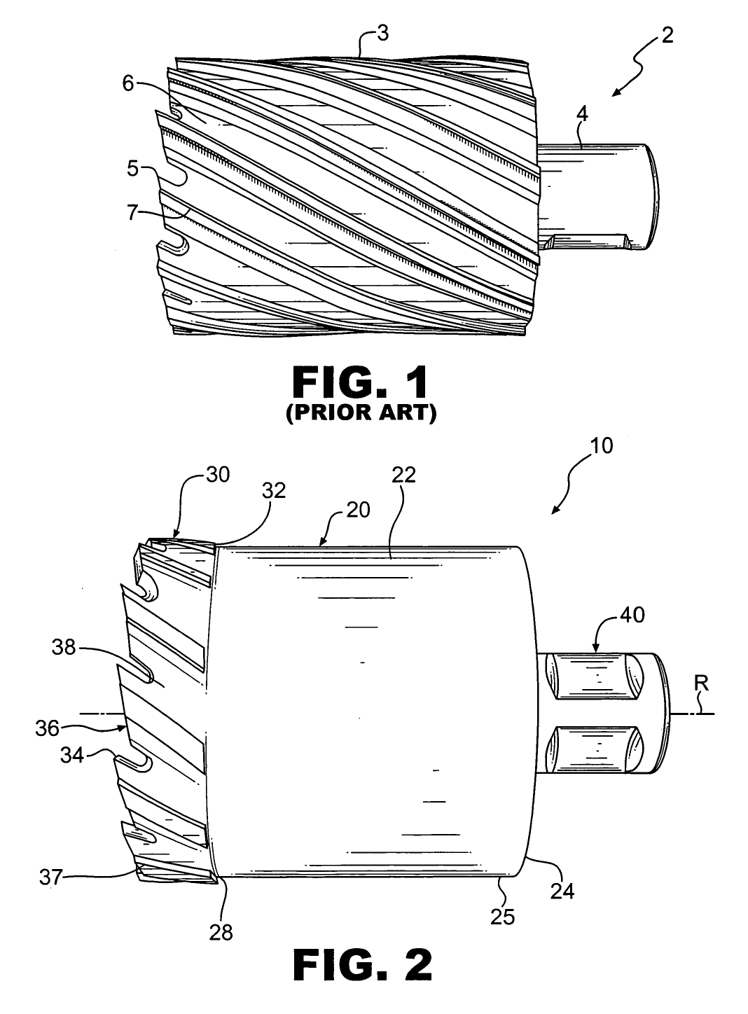

For these more demanding situations, an annular cutter may be used. An annular cutter is a machine tool typically used on magnetic base drills, drill presses, milling machines, and CNC machining applications. A prior art monolithic annular cutter 2 is shown in FIG. 1 and consists of a hollow cylindrical shell 3 having a shank 4 or stem at one end and axially projecting teeth 5 at the other end. The teeth 5 are separated by helical flutes 6 and helical cutting edges 7 extending from the cutting surface along the exterior of the cylindrical shell 3. Although not shown, the shank 4 typically includes an aperture for a pilot bit or pin which protrudes from the cutting edge of the annular cutter to guide the annular cutter during cutting. Annular cutters typically employ alternating tooth geometry to help minimize the cut area and evenly distribute chip load to multiple cutting edges, reducing horsepower and drilling feed pressure. Scrap material advances away from cutting edges, forming an easy-to-remove nest of chips above material surface. Annular cutters are manufactured from premium high-speed steel and specially heat-treated for cutting edge toughness increasing tool life between sharpening. Annular cutters are designed to increase through hole drilling productivity while improving hole accuracy, even in tough applications such as structural steel.

A problem with the prior art monolithic annular cutter is that it is relatively expensive. The annular cutter is typically manufactured from a solid high speed steel bar which must be machined, ground, heat treated, and finish ground. The high speed steel is a premium material, which is expensive. Deeper holes require longer annular cutters, which requires more material and more labor in machining and grinding. Due to the expense of the annular cutters, they are limited in their use to relatively expensive machines such as the magnetic base drills, etc. The cutters utilize a special monolithic shank which prevents their use in regular hand drills.

One prior art annular cutter has attempted to solve this problem by using tungsten carbide tips fixably attached to the leading end of a steel annular cutter. While these tungsten carbide teeth are particularly suitable for cutting rails and the like; the proper positioning, attaching, and machining of 4, 8, 12 etc. tungsten carbide tips can add significant cost to the production of the tool—especially in tooling required to properly position the tungsten carbide tips for attachment to the annular cutter body.

Accordingly, there is a need for a machine tool that combines the characteristics and properties of a low-cost hole saw with the speed and performance of an annular cutter. It would be an additional benefit if such a tool was versatile in that it could be used in both a regular hand drill as well as a magnetic base drill.

### SUMMARY OF THE INVENTION

The present invention overcomes at least one disadvantage of prior art machine tools. These and other advantages are provided by a hybrid machine tool identified as a hole cutter assembly combining the low cost of a hole saw with the performance of an annular cutter. The machine tool comprises a monolithic cutter ring member comprising a plurality of cutting teeth spaced circumferentially around a first end thereof, and a plurality of flutes, each flute formed in an outer cylindrical surface of the cutter ring member and extending from the first end to a second end of the cutter ring member. The machine tool further comprises a body member comprising a cylindrical portion having a first end and a second end, wherein the first end of the body member is fixably attached a second end of the cutter ring member and the second end of the body member comprises a top portion formed generally perpendicular to a longitudinal axis of the cylindrical member.

These and other advantages are also provided by a removable arbor for a machine tool, the arbor comprising: a cylindrical shank portion having a longitudinal axis and at least one flat formed in the cylindrical shank portion, the flat formed parallel to the longitudinal axis; a threaded portion axially spaced from the shank portion and coaxial with the shank portion; and a cylindrical aperture extending through the rotational axis of the arbor.

These and other advantages are also provided by a method for forming a machine tool comprising the steps of: providing a monolithic cutter ring of a first material; providing a body member of a second material, the body having a cylindrical portion having a first end and a second end; joining the cutter ring to the first end of the body member for a predetermined time and at a predetermined temperature to simultaneously provide a heat treatment of the cutter ring member; forming a plurality of teeth and a plurality of flutes in the monolithic cutter ring.

Further advantages of the hole cutter assembly will be apparent upon review of the detailed description of the present invention and associated drawings below.

### BRIEF DESCRIPTION OF THE DRA WINGS

FIG. 1 is a perspective view of a prior art annular cutter.

FIG. 2 is a perspective view of a first embodiment of the hole cutter assembly of the present invention;

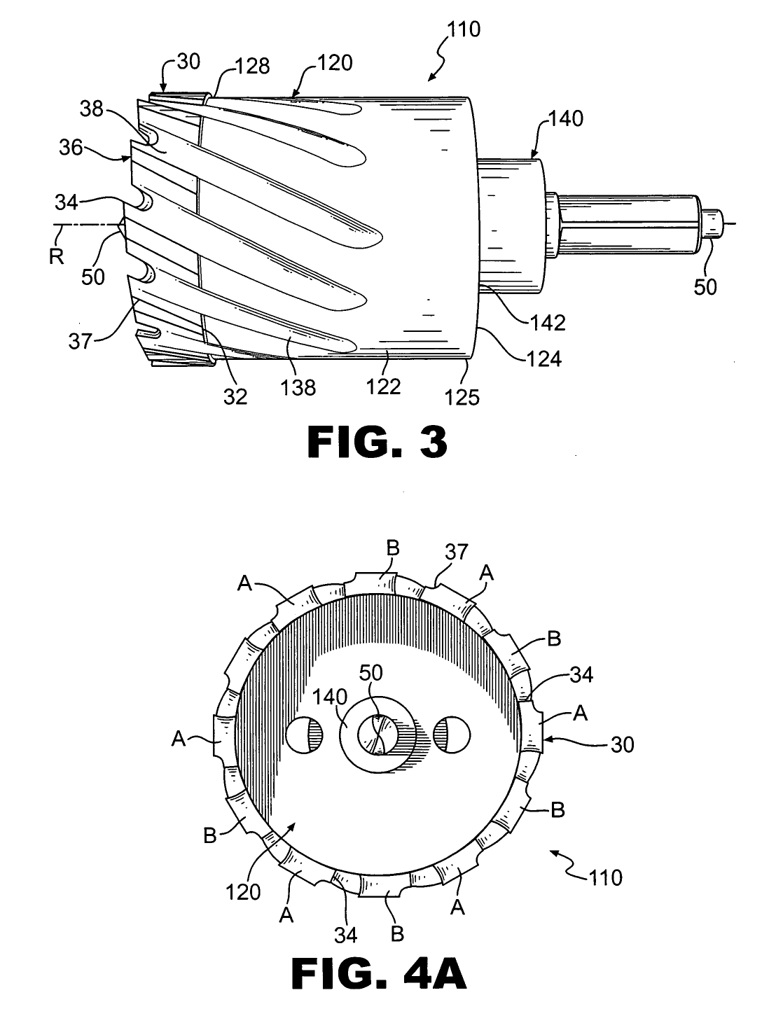

FIG. 3 is a perspective view of a second embodiment of the hole cutter assembly of the present invention;

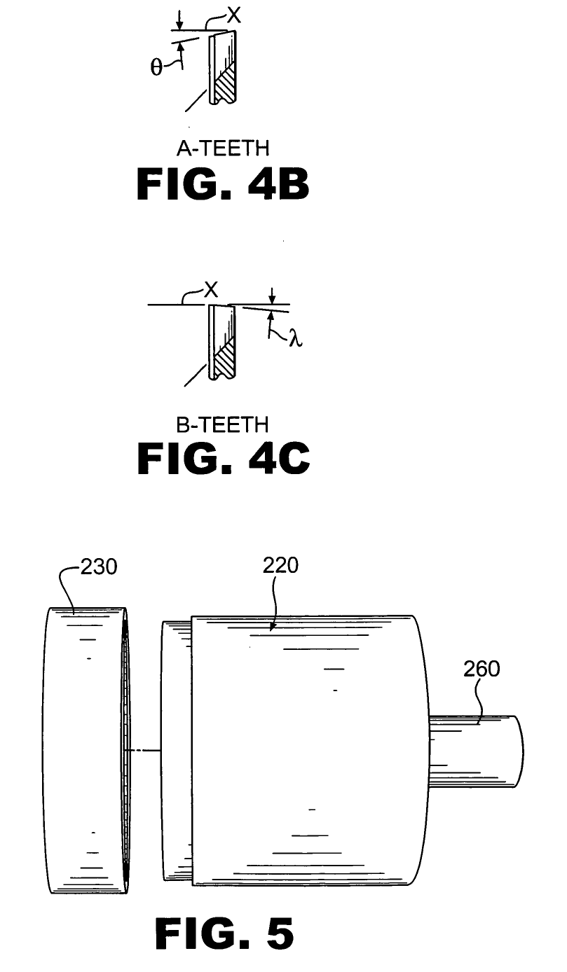

FIG. 4A is a cutting end view of the hole cutter assembly shown in FIG. 3; FIG. 4B is a partial cross-sectional view of a first alternating tooth of the cutting end of the hole cutter assembly of FIG. 3; FIG. 4C is a partial cross-sectional view of a second alternating tooth geometry of the cutting end of the hole cutter assembly of FIG. 3;

FIG. 5 is an exploded view of an embodiment of the hole cutter assembly of the present invention having an unfinished cutter ring and a carrier body shank or stem;

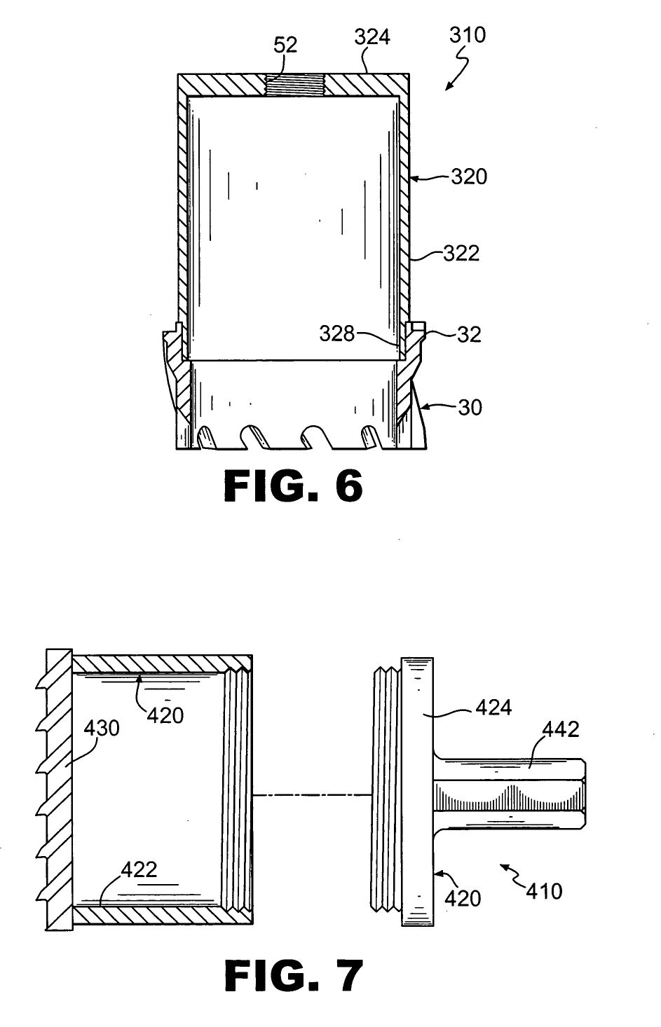

FIG. 6 is a cross-sectional view of an embodiment of the hole cutter assembly of the present invention;

FIG. 7 is a side elevational view of another embodiment of the present invention showing a demountable cap;

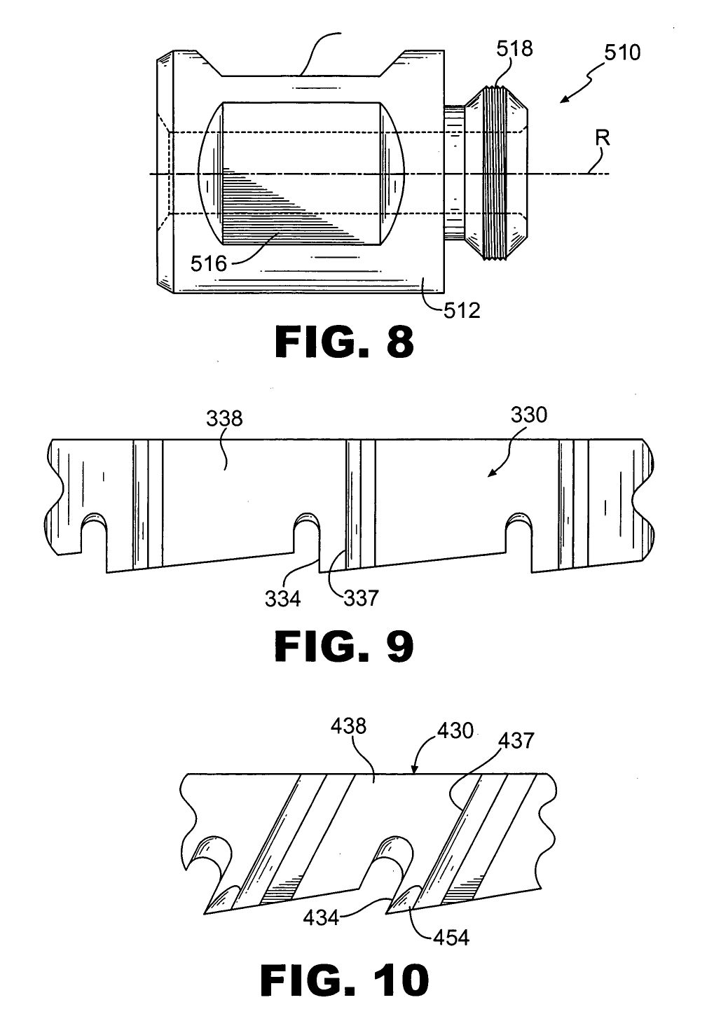

FIG. 8 is a side elevational view of another embodiment of the present invention showing a removable annular cutter style shank;

FIG. 9 is an un-wrapped side elevational view of another embodiment of the present invention showing a cutter ring having straight flutes;

FIG. 10 is an un-wrapped side elevational view of another embodiment of the present invention showing a novel clearance surface on the cutter ring;

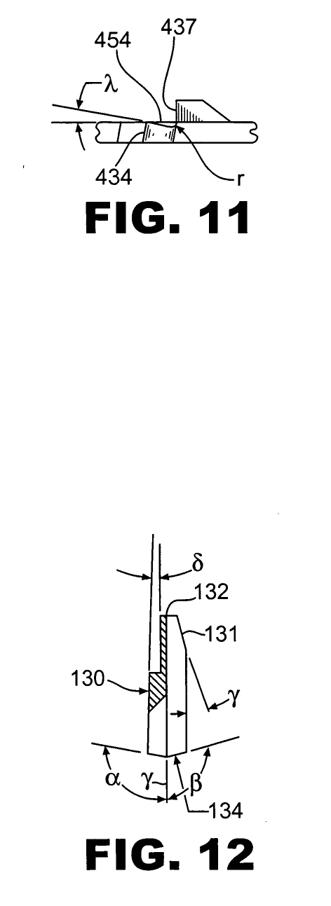

FIG. 11 is an unwrapped cutting end view of a portion of the cutting ring showing an embodiment featuring a novel clearance surface on the cutter ring; and

FIG. 12 is a cross-sectional view of an additional embodiment of the cutter ring showing a clearance chamfer on the trailing end of the cutter ring.

### DETAILED DESCRIPTION OF THE INVENTION

Referring to FIG. 2, a first embodiment of the hole cutter assembly 10 of the present invention is shown. The hole cutter assembly 10 comprises a carrier body 20 and a cutter ring 30. The carrier body 20 comprises a cylindrical portion 22 and a top portion 24. The cylindrical portion 22 having a first end 28 and a second end 25. The top portion 24 typically extends radially inward from the second end 25 of the cylindrical portion 22 of the body 20. The cutter ring 30 is similar to the cutting end of the prior art annular cutter 2. The cutter ring 30 comprises a plurality of axially projecting teeth 34 from a first end 36 of the cutter ring 30. A second end 32 of the cutter ring 30 is fixably attached to the first end 28 of the cylindrical portion 22 of the carrier body 20. A plurality of flutes 38 and cutting edges 37 are formed in the outer circumferential surface of the cutter ring 30 and extend from the first end 36 of the cutter ring 30 to the second end 32 of the cutter ring 30. Optionally, as shown in FIG. 3, the flutes 138 may be extended to the carrier 120 to help move chips away from the cutting ring 30. However, referring again to FIG. 2, it is contemplated that the flutes 38 limited to the axial length of the cutter ring 30 is sufficient to remove chips from the cutting area. The hole cutter assembly 10 may further comprise an arbor 40 that includes a shank portion of the type used with annular cutters. The annular cutter style arbor 40 may be formed as part of a monolithic body 20 or may be removable as discussed with regard to additional embodiments below. The hole cutter assembly 10 has a rotational axis R which also forms the cylindrical or longitudinal axis for the cutter ring 30 and the body 20 including the arbor 40.

A second embodiment of the invention is shown in FIG. 3. The hole cutter assembly 110 is shown with a hole saw style arbor 140. The top portion 124 of the carrier body 120 may have a threaded aperture (not shown) to receive a threaded end portion 142 of the hole saw style arbor 140. Arbor 140 is of the type typically used for standard hole saws and includes a pilot bit 50 attached to the arbor 140. The pilot bit 50 extends along the rotational axis R of the hole cutter assembly 110 and protrudes from the cutter ring 30 to guide the hole cutter assembly 110 during cutting. Although a pilot bit 50 is shown, the invention is not intended to be limited to a particular center configuration, alternative known configurations such as a spring loaded center pin (not shown), a solid shank, and any other known configurations are also contemplated. It is also contemplated that no guide or center member is needed for some applications and uses of the present invention. As previously discussed, flutes 138 are shown extended to the carrier 120 to help move chips away from the cutting ring 30. It is contemplated that flutes 138 may extend any axial distance along the cylindrical portion 122 of carrier 120 and may extend the entire axial distance between the first end 128 and the second end 125 of the carrier body 120.

As best shown in FIGS. 4A, 4B and 4C, the teeth 34 of the cutter ring 30, including cutting edges 37, may have an alternating tooth geometry to help minimize the cut area, known as the kerf, and evenly distribute chip load to multiple cutting edges reducing horsepower and drilling feed pressure. As best shown by the detail view in FIGS. 4B and 4C, the A teeth extend radially inward from the exterior of the cutter ring 30 and upward toward the body 120 at an angle θ with a plane perpendicular to the rotational axis, and the B teeth extend radially outward from the interior of the cutter ring 30 and upward toward the body 120 at an angle λ with a plane X perpendicular to the rotational axis. The height of the teeth 34 may also be of varying or alternating heights as is known in the art. In an alternative embodiment of the cutter ring 130, shown in FIG. 12, the teeth 134 may have an apex between the inner and outer edges of the ring 130 and extend radially inward and outward from the apex and upward toward the body (not shown) at an angle α and β, respectively, with a line Y parallel to the rotational axis. The invention is not intended to be limited to the particular tooth geometries shown.

Referring again to FIG. 4A, the cutter ring 30 also enables the radial width of the cutting surfaces to be minimized as the additional strength of the carrier body 120 over that of the prior art annular cutter walls enables less material to be used without reducing strength or life of the cutting edges. This allows a smaller kerf and less material removal, further reducing the energy required to make the cut.

The hole cutter assembly of the present invention may be made significantly cheaper than prior art annular cutters. The cutter ring may be manufactured of premium high-speed steel such as M42, or a carbide material or any other suitable material. It is further contemplated that the cutter ring is formed as a bi-metal ring in a similar fashion as that of bi-metal hole saws. Regardless of the material, the cutter ring requires significantly less of the expensive cutting material than required with a prior art annular cutter. To further reduce costs, the cutter ring can be produced as an investment casting, powder metal, or metal injection mold, with or without flutes, then machined, ground, or machined and ground. Referring now to FIG. 5, a cutter ring blank 230 is shown prior to attachment to a monolithic carrier blank 220 having an integral cylindrical shank 260. The cutter ring blank 230 is not limited to the ring shown and may have preformed flutes and teeth formed or cast therein which can later be finish machined and/or ground after the cutter ring is fixably attached to the carrier body; In the embodiment shown the cutter ring blank 230 is attached to the carrier blank 220 and then the plurality of teeth and flutes are formed on the cutter ring blank. The carrier blank 220 can be manufactured of a relatively inexpensive steel material such as 4150 steel and does not require extensive additional machining or grinding. In the embodiment shown, the carrier blank includes a shank blank portion 260 that is monolithically formed with the carrier body blank 220 similar to the prior art annular cutter 2. The appropriate attachment features are machined into the shank blank portion 260 such as Weldon flats or other attachment features of the type used with prior art annular cutters. Although shown as a monolithic carrier body blank 220, it is contemplated that the carrier blank 220 could include a threaded aperture formed before or after the attachment of the cutter ring and the carrier body, for use with a removable arbor.

With prior art annular cutters, deeper drill depths require longer tools. This significantly increases the material and manufacturing cost of the prior art annular cutter. In the present invention, longer holes can be machined by increasing the length of the carrier body. As the carrier body is made of an inexpensive material, and increasing the length of the cylindrical portion results in a negligible increase in material and production cost. Another advantage is that the carbon steel cylindrical body does not require flutes and can be made significantly thinner than the prior art monolithic annular cutters. This allows a thinner cylinder wall and a thinner cutter ring resulting in a smaller kerf. The smaller kerf allows increased speed of the cut and requires less energy to remove less metal.

As shown in cross-section in FIG. 6, an embodiment of the hole cutter assembly 310 is shown utilizing a carrier 320 adapted for use with a removable arbor and a cylindrical portion 322 shown without flutes. The cutter ring 30 is shown attached to the carrier body 320. The top portion 324 of the carrier body 320 includes an aperture 52 for connection of an arbor or removable shank. The first end 328 of cylindrical portion 322 of the carrier body 320 has a reduced outer diameter forming a connecting portion with the second end 32 of the cutter ring 30, which has a reduced inner diameter. The stepped connection of the cutter ring 30 and the carrier body 320 is not intended to be limited to the configuration shown and other configurations may be possible. In manufacturing the present invention, the attachment of the body 320 and the cutter ring 30 may be made by a joining process such as brazing, laser welding, projection welding, friction welding, or other methods. In one embodiment, using a cutter ring 30 of premium high speed steel and a carrier body 320 of carbon steel, a brazing process is used to connect the two parts. The brazing material is selected such that the brazing process is at a predetermined temperature and over a predetermined time period to simultaneously provide a heat treatment of the cutter ring material at the same time and temperature that the brazing material can flow to provide a secure and fixed attachment of the ring 30 and the body 320. Such a brazing process may be accomplished in a controlled-atmosphere or vacuum furnace, for example. Other such brazing methods are also contemplated and the present invention is not intended to be limited to a particular brazing process.

It is also noted that the cylindrical portion 322 of the carrier body 320 has an innermost diameter larger than the innermost diameter of the cutter ring 30 and an outermost diameter smaller than the outermost diameter of the cutter ring 30. This provides clearance for the body 320 when cutting through a material. In addition, as shown in the cutter ring embodiment of FIG. 12, the second end 132 or trailing end of the cutter ring 130 may also have a chamfer 131 formed on the radial outwardmost portion at an angle γ to provide clearance leading from the cutter ring 130 to the body. The interior cylindrical surface of the cutter ring 130 may also be provided with a clearance as shown by taper angle δ or an appropriate chamfer.

Referring to another embodiment of the hole cutter assembly 410 as shown in FIG. 7, having a two-part carrier body 420 in which the top portion 424 carrier body 420 may be demountably attached to the cylindrical portion 422 of the carrier body 420. As shown in the exploded view, end portion 424 is threadably attachable to the cylindrical portion 422. A locking device, not shown, may be needed to prevent decoupling during reverse operation of the hole cutter assembly 410. While a threaded connection is shown, the invention may include other demountable configurations and is not intended to be limited to the example shown. The demountable end portion 424 allows easy removal of the machined material core from the hole cutter assembly 410. Another advantage of the demountable end portion 424 is that each end portion may have a different shank configuration to allow for compatibility on multiple different machines. While a hole saw arbor style shank 442 is shown integrally formed with the top portion 424, it is contemplated that an annular cutter style arbor shank (not shown) could be integrally formed on another top portion and interchanged as needed with the hole saw arbor style end portion 424. It is also contemplated that demountable end portion 424 could be formed with a centrally positioned aperture similar to that shown in FIG. 6 such that arbor 424 is demountably attached to the end portion 424.

Another embodiment of the present invention is shown in FIG. 8, and comprises a removable arbor 510 that includes a shank portion 512 of the type used with annular cutters. The removable arbor 510 comprises a generally cylindrical shank portion 512 having a longitudinal axis R and at least one flat 516 formed in the cylindrical shank portion. The flat portions 516 are formed parallel to the longitudinal axis R and are typically referred to as Weldon flats. Although not shown, it is contemplated that the cylindrical shank portion 512 may also include various depressions, dimples, grooves, or other features that are used by various annular cutter manufacturers as an alternative shank gripping feature to Weldon flats. The replaceable arbor 510 further comprises a threaded portion 518, axially spaced from the shank portion 512 and coaxial with the shank portion 512. The threaded portion 518 mates with the threaded aperture 52 of the hole cutter 310 shown in FIG. 6. It is preferred that the threads used on the removable arbor 510 are formed with threads having a tight tolerance such as class 3 threads or the like. This will help ensure that the arbor is properly centered in the tool. Other attachment methods are also contemplated and the invention is not intended to be limited to a threaded connection. The replaceable arbor 510 provides versatility to the hole cutter 310 in that it can be used both as a hole saw with tools that utilize a hole saw arbor and as an annular cutter with tools that utilize the arbor shank of an annular cutter. A further advantage provided by the replaceable arbor 510 is that it will allow existing hole saws to be used with tools that are only compatible with the shank of an annular cutter, such as a magnetic drill.

Another embodiment is shown in FIG. 9 which shows an unwrapped side view of a cutter ring 330 having teeth 334 and flutes 338 parallel to the rotational axis of the hole cutter assembly (not shown). The straight flutes 338 and corresponding cutting edges 337 are easier to manufacture than helical flutes 38, 138 of the earlier embodiments, providing an even greater time and manufacturing cost advantage. In some cutting applications of some materials, there is no appreciable loss in cutting efficiency and performance.

Another advantage provided by another embodiment of the invention is a clearance structural feature best shown in FIGS. 10 and 11. FIG. 10 shows an unwrapped side view of a cutter ring 430 having flutes 438 and cutter teeth 434. A clearance surface 454 is formed on the radially outward surface of the teeth 434 at an angle λ toward the trailing flute 438 and meeting with the flute 438 at a radius r as best shown in FIG. 11. The surface 454 provides clearance between the radial outward edge of the cutting tooth 434 and the radial inward portion of cutting edge 437. This feature prevents drag on the radial outward surface of the ring between the tooth 434 and the cutting edge 437 and provides a significant advantage over existing annular cutters.

Although the present invention has been described above in detail, the same is by way of illustration and example only and is not to be taken as a limitation on the present invention. Accordingly, the scope and content of the present invention are to be defined only by the terms of the appended claims.

1. A machining tool comprising:
a monolithic cutter ring member comprising a plurality of cutting teeth spaced circumferentially around a first end thereof, and a plurality of flutes, each flute formed in an outer cylindrical surface of the cutter ring member and extending from the first end to a second end of the cutter ring member; and
a body member comprising a cylindrical portion having a first end and a second end, wherein the first end of the body member is fixably attached to a second end of the cutter ring member and the second end of the body member comprises a top portion formed generally perpendicular to a longitudinal axis of the cylindrical member.

2. The machining tool of claim 1, wherein the cutter ring member is made of a different material than the body member.

3. The machining tool of claim 1, wherein the cutter ring member is joined to the body member.

4. The machining tool of claim 1, wherein the plurality of flutes are helically formed in the cutter ring.

5. The machining tool of claim 1, wherein the plurality of flutes are parallel to a rotational axis of the tool.

6. The machining tool of claim 1, wherein the top portion of the body member comprises an aperture for attachment of an arbor.

7. The machining tool of claim 1, wherein the body member is monolithic and further comprises an arbor portion.

8. A machining tool comprising:
a monolithic cutter ring member comprising a plurality of cutting teeth spaced circumferentially around a first end thereof, and a plurality of flutes, each flute formed in an outer cylindrical surface of the cutter ring member and extending from the first end to a second end of the cutter ring member; and
a body member comprising a cylindrical portion having a first end and a second end, wherein the first end of the body member is fixably attached a second end of the cutter ring member and the second end of the body member comprises a top portion formed generally perpendicular to a longitudinal axis of the cylindrical member;
wherein the top portion of the body member includes an aperture located at a rotational axis of the machining tool.

9. The machining tool of claim 8 further comprising an arbor demountably attachable to the top portion of the body member at the aperture.

10. The machining tool of claim 9, wherein the arbor demountably attachable to the aperture by means of a threaded engagement.

11. The machining tool of claim 8, wherein the cutter ring member is joined to the body member.

12. The machining tool of claim 8, wherein the plurality of flutes are helical.

13. The machining tool of claim 8, wherein the plurality of flutes are parallel to a rotational axis of the tool.

14. The machining tool of claim 8, wherein the axial length of the cutter ring is less than half the axial length of the body member.

15. A machining tool comprising:
a monolithic cutter ring member made of a first material and comprising a plurality of cutting teeth spaced circumferentially around a first end thereof, a plurality of flutes formed in an outer cylindrical surface of the cutter ring member, the plurality of flutes extending from the first end to a second end of the cutter ring member;
a body member made of a second material different from the first material, the body member comprising a cylindrical portion having a first end and a second end, wherein the first end is fixably attached to a second end of the annual ring member and the second end of the body member comprises a top portion formed generally perpendicular to a longitudinal axis of the cylindrical member; and
an arbor demountably attached to the top portion of the body member.

16. The machining tool of claim 15, wherein the arbor comprises:
a cylindrical shank portion having a longitudinal axis and at least one flat formed in the cylindrical shank portion, the flat formed parallel to the longitudinal axis of the shank portion; and
a threaded portion, axially spaced from the shank portion and coaxial with the shank portion.

17. The machining tool of claim 15, wherein the plurality of flutes are helical.

18. The machining tool of claim 15, wherein the plurality of flutes are parallel to the longitudinal axis of the cylindrical member.

19. A method for forming a machine tool comprising the steps of:
providing a monolithic cutter ring having a first end, a second end, and made of a first material;
providing a body member comprising a cylindrical portion having a first end, a second end, and made of a second material;
joining a second end of the monolithic cutter ring member to the first end of the body member for a predetermined time and at a predetermined temperature to simultaneously provide a heat treatment of the monolithic cutter ring member;
forming a plurality of teeth on the first end of the monolithic cutter ring; and
forming a plurality of flutes in the monolithic cutter ring.

20. The method of claim 19, wherein the step of providing an cutter ring comprises the step of forming the cutter ring by the process of an investment casting, powdered metal, a metal injection molding, or a cylindrical blank cut to axial length.

21. A removable arbor for a hole saw tool, the arbor comprising:
a cylindrical shank portion having a longitudinal axis and at least one flat formed in the cylindrical shank portion, the flat formed parallel to the longitudinal axis;
an exterior threaded portion, axially spaced from the shank portion and coaxial with the shank portion; and
a cylindrical aperture extending through the rotational axis of the arbor.

22. The arbor of claim 21, wherein the threaded portion includes universal series class 3 threads.
